(19) United States
(12) Patent Application Publication
(10) Pub. No.: US 2003/0132094 A1
(43) Pub. Date: Jul. 17, 2003

(54) Membrane switch

(76) Inventors: Marlin H. Mickle, Pittsburgh, PA (US); Harold Swift, Gibsonia, PA (US); Christopher C. Capelli, Kenosha, WI (US)

Correspondence Address: ECKERT SEAMANS CHERIN & MELLOTT, 600 GRANT STREET, 44TH FLOOR, PITTSBURGH, PA, 15219

(21) Appl. No.: 10/281,737

(22) Filed: Oct. 28, 2002

Related U.S. Application Data
(60) Provisional application No. 60/349,879, filed on Jan. 17, 2002.

(51) Int. Cl. H01H 3/20

(52) U.S. Cl. 200/539; 340/540

(57) ABSTRACT

The present invention provides a membrane switch which has a static layer and a flexible membrane layer disposed adjacent to each other with one or more pairs of aligned electrical poles such that the switch may assume an electrically closed position and an electrically open position. A transmitter is integrally provided within the switch, preferably in the static layer and transmits signals responsive to closing of the switch or keystrokes applied thereto. A receiver receives the signals and in cooperation with the microprocessor delivers responsive output to an electronic circuit or system. Direct physical connections between the switch and the circuit or systems are not required.

This application claims the benefit of U.S. Provisional Patent Application Serial No. 60/349,879, filed Jan. 17, 2002.

### BACKGROUND OF THE INVENTION

1. Field of the Invention

The present invention relates to an improved membrane switch assembly and more specifically, it relates to one wherein the membrane switch contains an integral transmitter which provides output to a receiver which is operatively associated with an electronic circuit or system, thereby eliminating the need for a hardwired connection.

2. Description of the Prior Art

It has long been known to provide membrane switches wherein an electrical connection is provided between a substrate and a deformable membrane so as to facilitate opening and closing the switch by deformation of the membrane which is normally in a switch open position. It has also been known to provide hardwired connections between the switch and another circuit component. See generally U.S. Pat. Nos. 4,484,039 and 5,934,933.

Membrane switches are typically constructed of a number of layers of materials such as polycarbonate on polyester assembled with hard, permanent acrylic adhesives. The opposed switch electrodes are provided on opposed surfaces with circuit conductors being provided to extend between and among the electrodes. These conductive elements generally are established through printing by well-known printed circuit techniques employing silver-filled resins.

Membrane switches are typically flat and may have a thickness of less than 0.1 inches. They may be provided flush against the surface of an instrument or device to which they are attached. It is known to adhere the membrane switch to a flat support panel on an instrument being controlled, as by mechanical fasteners, such as screws, or a suitable adhesive.

Generally, membrane switches have been connected to external electronic circuits or systems employing conductor cables or direct connection to a chassey, printed circuit board, electronic device or the like. These electronic circuits are typically located in the instrument or device that is being controlled by the membrane switch.

U.S. Pat. No. 6,289,237 discloses a base station which provides a source of energy to energize a cooperating remote station which may monitor a system and transmit data back to the base station.

Despite the foregoing known switches, there remains a very real and substantial need for a membrane switch which can eliminate the need for hardwired connections between the switch and the cooperating or controlled electronic circuit or system thereby eliminating the inherent disadvantages of such known systems.

### SUMMARY OF THE INVENTION

The present invention has met the above-described need.

A membrane switch has a static layer having at least one electrical pole. A flexible membrane layer is disposed adjacent to and generally moveable with respect to the static layer and has at least one electrical pole aligned with the static layer electrical pole or poles. The membrane layer is flexible and is structured to assume a first position with the electrical pole or poles in electrical contact with the pole or poles with the static layer i.e., switch closed position, and a second position wherein such pole to pole contact is not provided i.e., switch open position. A membrane switch transmitter is structured to transmit signals when the membrane switch is in a closed position. A membrane switch receiver, which is remotely positioned with respect to said transmitter and is operatively associated with an electronic circuit or a system receives signals from the transmitter and delivers responsive signals to the electronic circuit or system.

The membrane switch is normally in a switch open position and may be flexibly deformed to close the switch with responsive transmission of signals from the transmitter to the receiver.

The transmitter may have an energy harvesting unit, such as a solar unit, for receiving energy and may cooperate with a power storage unit, such as a battery, for storing such energy with a microprocessor receiving input and providing responsive output for transmission by the transmitter.

The receiver assembly may have digital logic or a microprocessor for receiving signals from the receiver responsive to its receiving the transmitted signals and providing output through a mechanical/electrical interface to an electronic circuit or system.

It is an object of the present invention to provide an improved membrane switch which does not require hardwiring or other direct physical connections between one portion of the switch and the portion operatively associated with an electronic circuit or system.

It is a further object of the present invention to provide a membrane switch which has an integral transmitter assembly which is structured to transmit signals through the air responsive to closing of a conductive path by closing the switch or a keystroke action.

It is a further object of the present invention to simplify the construction of electronic circuits or systems which are activated and deactivated by the membrane switch by requiring less components and avoiding a partial destruction of integrity of the circuit or system.

It is yet another object of the present invention to provide such a membrane switch, which in compatible with prior circuits and systems used with such switches.

It is yet another object of the present invention to provide such a membrane switch, which may be produced and employed economically.

These and other objects of the invention will be more fully understood from the following detailed description of the invention on reference to the illustrations appended hereto.

### BRIEF DESCRIPTION OF THE DRAWINGS

FIG. 1 is a schematic illustration of a form of known membrane switch.

FIG. 2 is a schematic illustration of a membrane switch of the type shown in FIG. 1 as connected to an electronic circuit or system through a hardwired connection.

FIGS. 3a and 3b show, respectively, an embodiment of the first invention with the switch and its associated transmitter as well as the switch receiver and its associated electronic circuit or system.

FIGS. 4a and 4b, respectively, show a form of transmitter assembly and a form of receiver assembly employable in the present invention.

FIG. 5 shows an exploded view of a portion of a membrane switch of the present invention.

### DESCRIPTION OF THE PREFERRED EMBODIMENT

As employed herein, the term “membrane switch” means a momentary switch device in which at least one contact is in, on or made of a flexible substrate and wherein there is direct ohmic contact between the poles of the switch when the switch is in an electrically energized or closed position. Such membrane switches, as contemplated herein, will upon release, result in the poles separating due to the flexing of the membrane returning it to its original switch open position. The membrane switches are frequently employed in low voltage, DC logic-level-signal applications. In general, the membrane layer will be a flexible thin layer that carries one pole or both poles and flexes during switch operation. In the one pole approach, a cooperating pole will be provided on the static layer with contact between the two poles responsive to movement of the flexible membrane serving to close the switch. When two spaced poles are provided on either the membrane or static layer a conductive shorting member that provides an ohmic contact between the two poles is provided on the other such that closing contact between the membrane and static layer will effect electrical contact between the shorting member and poles to thereby close the switch. The static layer may be of a type that does not flex during switch operation and carries one pole or both poles or the shorting member with the flexible membrane carrying the respective cooperating member or members.

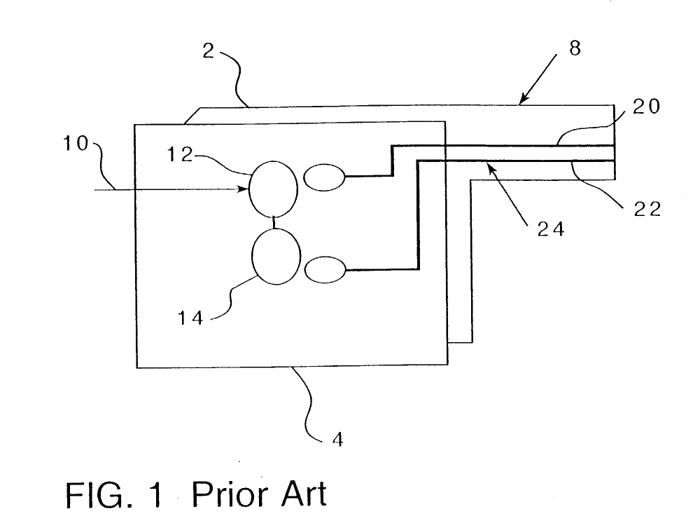

Referring to FIG. 1, there is shown a schematic illustration of a form of known membrane switch. The switch has a static layer 2, a superposed and closely adjacent flexible membrane layer 4 and, a tail 8. In the form shown, the membrane layer 4 has a direct contact 10 which consists of a first electrical pole 12 and a second electrical pole 14 which overlies and is in the switch open position in spaced relationship to a pair of poles (not shown) secured to static layer 2. It will be appreciated that at least one pair of poles must be provided, but two or more pairs may be employed if desired. When the membrane layer 4 is moved toward the static layer 2, the poles contact each other thereby completing the circuit and providing electrical output signals on leads 20, 22 which are the conductive elements 24 and generally would be provided by printed circuit conductive paths. When the deforming force applied to membrane layer 4 and establishing closing of the switch is withdrawn, the flexible material of the membrane layer 4 will cause it to move away from static layer 2 thereby opening the switch and terminating signal transmission.

The printed electrical conductive elements such as 20, 22 generally extend into the tail 8 which is typically an extension of the static layer 2 or if the substrate in a particular installation is also composed of flexible material as an extension of the substrate.

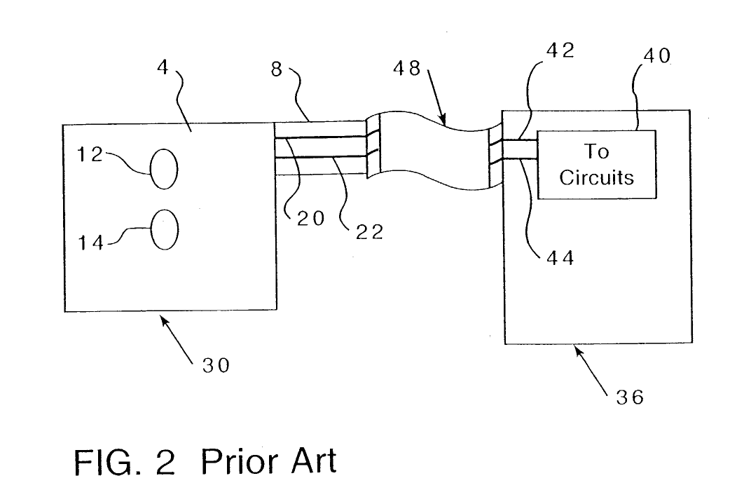

Referring to the prior art switch and related controlled circuits or systems of FIG. 2, the membrane switch 30 has a membrane layer 4 and electrically conductive poles 12, 14 with the tail 8 having a pair of printed circuit electrically conducted paths 20, 22. The circuit board 36 contains a plurality of circuits shown schematically by block 40, which have a pair of printed circuit conductive paths 42, 44 electrically connected thereto. The prior art system has hardwired conductor cable 48 connecting the membrane switch 30 with a circuit board 36 to thereby cause the signals emitted through the membrane switch 30 received by the switch 30 to be received by the circuit board 36. In lieu of the conductor cable 48, some prior art systems employ direct connection of the switch to a chassey, printed circuit board, electronic system or other device. The electronic circuits are typically located in an instrument or device that is being controlled by the membrane switch.

The tail 8 of the membrane switch generally consists of multiple silver conductors printed on the static layer such that they can be connected to an external electronic circuit board using conductor cables such as 48. Most switch interconnects are designed for 0.100 inch centerlines spacing, but may be of a variety of spacing and forms. This configuration tends to be standard throughout the electronics industry for routine interconnects between devices and components.

One problem with the prior art approach to connecting the membranes with the external circuit board or system is that it requires conductor cables. This results in there necessarily being a physical route for the connector cable to be established between the external electronics circuit or system that resides in the instrument or device and the surface of the instrument or device to which the membrane switch is attached. This results in limiting the design flexibility of the instrument or device. The placement of the membrane switch is restricted to locations on the instrument or device panel in which the connector cable can be routed physically to the external electronic circuit.

Another problem with the prior art approach is that the physical integrity of the case or container of the external electronic circuit board of system is compromised in order to permit the physical connection of the electrical conductor cable between the membrane switch and the electronic circuit or system. Further, in situations when the atmospheric conditions or other external conditions may affect the electronic circuits, a case or container that has limited openings is highly desirable.

A further problem with prior art approaches is that connecting membrane switches with external electronic circuits or systems requires the additional costs associated with connector cables, connector-locking mechanisms and associated elements.

Another known method of making connections to non-exposed electronic circuits is to drill holes or vias through the circuit board or dielectric film and fill the vias with an electrically conducted material. The electrical terminations that are not exposed can be routed to surfaces that are exposed and then connected in traditional ways through the holes or vias. The difficulty with this approach is the increased complexity of manufacturing and the corresponding increase in cost of manufacturer.

Another approach to connecting the internal surface is to cut one or more of the outside circuit boards and dielectric films short. In this manner, the internal conductive paths can be exposed as they will project beyond the opposing electronic circuit boards that covers the majority of the circuit to be connected. This approach, however, has shortcomings as it poses additional considerations of connecting to circuits on the bottom side of a cut back layer.

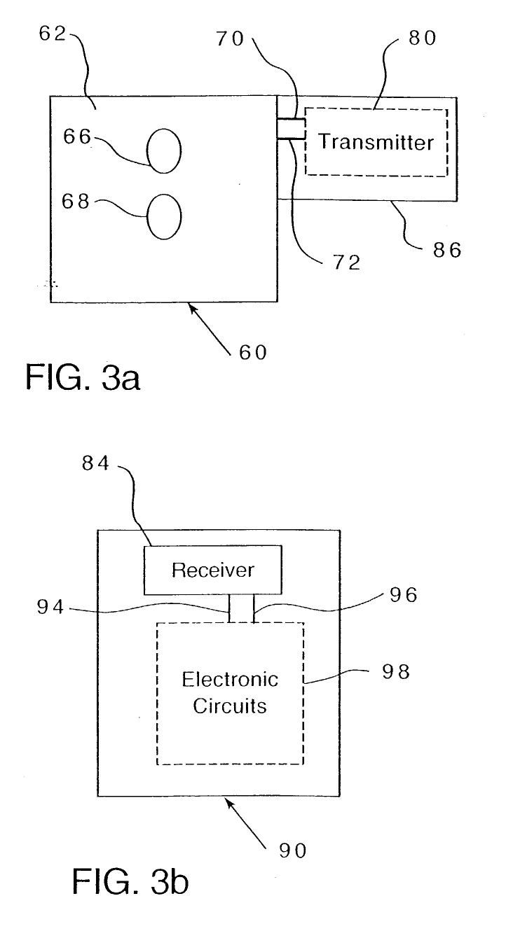

With reference to FIGS. 3a and 3b it will be seen that the present invention provides improved membrane switch assemblies that require no direct physical means of connecting the membrane switch to be external electronic circuit or system. It eliminates the need for vias or conductor cables previously required in effecting a connection between the membrane switch and the external electronic circuit board. This results in not only enhanced simplicity of manufacture and reduced costs, but also increases flexibility and design of the instrument and other electronic devices that employ membrane switches for their control.

The invention also provides a membrane switch assembly that can transmit keystroke information to a receiver on an external electronic circuit board system without the need for physical connector cables.

Referring again to FIGS. 3a and 3b the membrane switch 60 of the present invention has a flexible membrane layer 62 overlying a static layer (not shown). The switch 60 in the form shown has a pair of electrically conductive poles 66, 68 which upon deformation of membrane layer 62 will cause them to come into contact with corresponding electrical poles (not shown) on the static layer. This causes closing the switch and causing signals to pass on printed circuit electrically conductive lines 70, 72 to membrane switch transmitter 80 which, in the manner to be described hereinafter, will transmit signals through the air or other suitable media to be received by membrane switch receiver 84. The signals are preferably RF signals. The transmitter is preferably integrally formed in the tail 86 and preferably will not extend beyond any defined boundary for a system of switches. The receiver 84 is preferably secured to circuit board 90 and has output over electrically conductive printed circuit lines 94, 96 to the electronic circuits 98. It will be appreciated that, in the manner to be described hereinafter in greater detail, in this way without requiring any direct physical connection between the membrane switch activating portion and the electronic circuit or system being controlled effective communication, therebetween, is established. The system communicates keystrokes or membrane switch closings with the receiver 84, which is operatively associated with the circuit board 90 and the electronic circuits 98 being controlled.

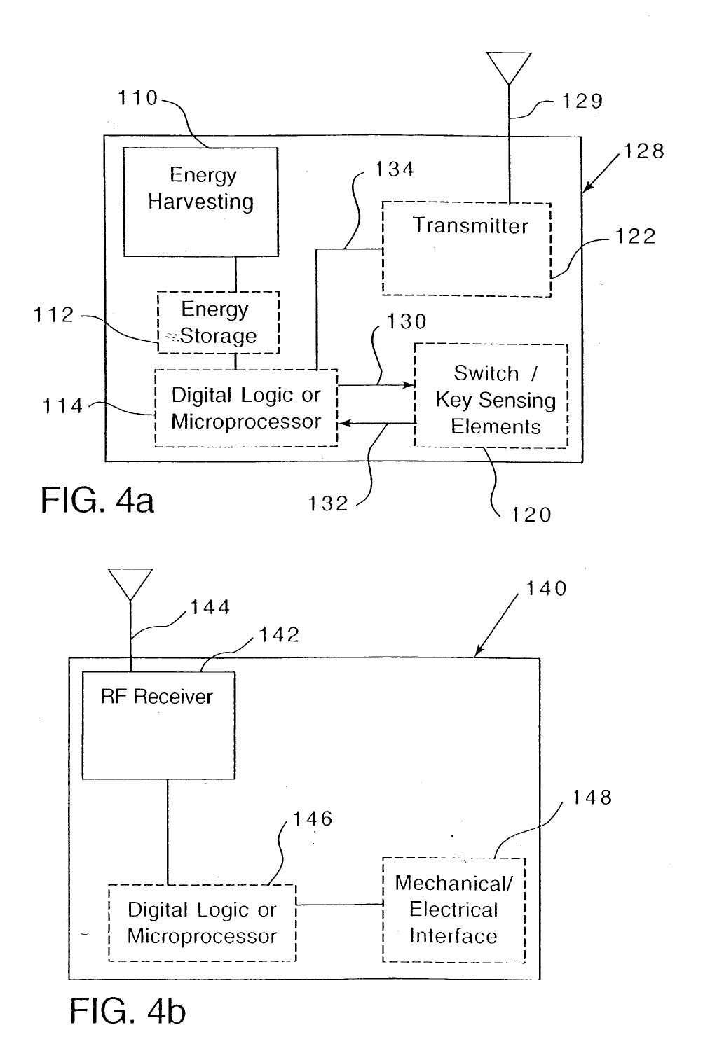

Referring to FIG. 4a, there is shown a preferred form of transmitter assembly 128. The transmitter assembly 128, in the form shown, contains an energy harvesting element 110 which, may for example, be a solar cell which produces output to an energy storage unit 112, which may be a suitable battery, which in turn is connected to cooperating digital logic or a microprocessor 114. Any suitable alternate source of energy such as a battery, for example, may be employed in lieu of energy harvesting element 110, if desired. The switch/key sensing element 120 senses keystroke or switch closure and, communicates with digital logic or microprocessor 114, which effects the responsive output from transmitter 122, which may be a RF transmitter having antenna 129. The transmitter is preferably on a RF transmitter in an appropriate ISM or other band. In sensing the keystroke or switch closure, the digital logic or microprocessor 114 may output to switch/key sensing elements 120 a binary coded numerical sequence on line 130 and will read the incoming binary coded numerical sequence received from switch/key sensor 120 on line 132 and, responsively at the appropriate time emit a signal over line 134 to transmitter 122 which has antenna 129. The digital logic or microprocessor 114 reads the appropriate key and formats a code that is sent to the transmitter 122 directly or as part of the frame formed using software in the digital logic or the microprocessor. The RF transmitter 128 transmits the code/frame. Referring to FIG. 46, the receiver 140 receives the RF energy through antenna 144 and forms a digital signal that is input and decoded in the digital logic or the microprocessor 146. The keystroke is then encoded in an appropriate form for use in the circuit or system. The appropriate form is then input to the system through the mechanical/electrical interface 148.

It is preferred that the transmitter assembly 128 be fully integrated into the membrane switch static layer with the printed electronic conductive elements of the static layer being employed to connect the different components of the membrane switch transmitter assembly 128.

Referring to FIG. 4b, this illustrates a preferred form of membrane switch receiver assembly 140. This includes a receiver 142, having antenna 144, which receives signals of transmitter 122 through the air and outputs responsive signals to digital logic or microprocessor 146 to store and format the output of receiver 142 and to provide an appropriate digital code preferably in the form of a binary sequence to the input into the external electronic circuit or system, where appropriate through mechanical/electrical interface 148.

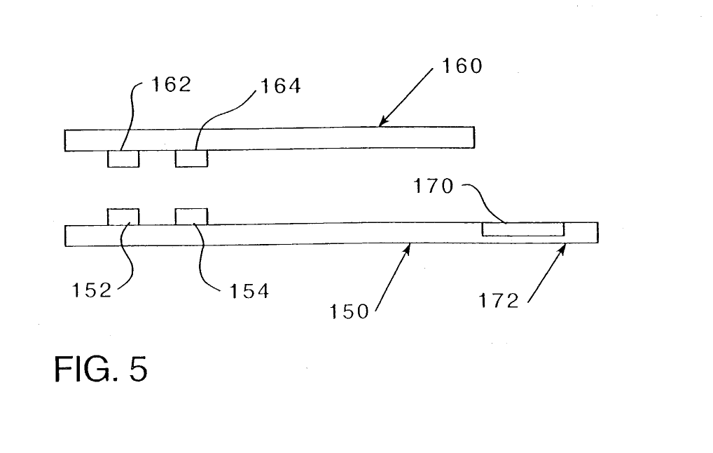

FIG. 5 shows an exploded view of a form of membrane switch showing the static layer 150 and a pair of electrical poles 152, 154 with an overlying flexible membrane 160 having a pair of poles 162, 164 overlying static layer poles 152, 154. Integrally positioned within the static layer is the transmitter assembly 170, which in the form shown is positioned within the tail 172.

It will be appreciated that the present invention provides a membrane switch which through opening and closing of the membrane switch or applied keystrokes processes information and through an integrally contained transmitter provides the information to the membrane switch receiver whose output is operatively associated with the electronic circuit or system desired to be controlled. Appropriate digital logic or microprocessors are provided in the transmitter assembly and receiver assembly with an energy source being provided in the former. An appropriate mechanical/electrical interface is provided between the receiver digital logic or microprocessor and the circuit or system being controlled. All of this is accomplished without requiring direct cable or other physical connections between the switch and the electronic circuit or system being controlled.

Whereas particular embodiments of the invention have been described herein for purposes of illustration, it will be evident that those skilled in the art that numerous variations of the details may be made without departing from the invention as set forth in the appended claims.

What is claimed is:

1. A membrane switch comprising
a static layer having at least one static layer electrically conductive member,
a flexible membrane layer disposed adjacent to such static layer and having at least one membrane layer electrically conductive member positioned for engagement with said electrically conductive member of said static layer,
said flexible membrane layer being moveable with respect to said static layer to assume a closed position with said at least one static layer electrically conductive member in electrical contact with said at least one said membrane layer conductive member and an open position wherein said electrically conductive members are not in electrical contact and,
a membrane switch transmitter assembly integrated into said membrane switch for transmitting signals responsive to said switch being in said closed position and a membrane switch receiver for receiving said signals from said transmitter without requiring a physical connection between said transmitted assembly and said receiver.

2. The membrane switch of claim 1 including said transmitter structured to transmit RF signals.

3. The membrane switch of claim 2 including said membrane switch being structured to be in said open position when no membrane deforming force is applied to said membrane layer and to be placed in said closed position responsive to application of deforming force thereto.

4. The membrane switch of claim 3 including said membrane switch having one said membrane layer electrically conductive element generally aligned with one said static membrane layer electrically conductive member.

5. The membrane switch of claim 1 including said membrane switch transmitter having an energy harvesting unit for receiving energy and a power storing unit for receiving energy from said energy harvesting unit and storing said energy, and
a microprocessor for receiving input when said switch is in said closed position and a transmitter for transmitting responsive signals to said receiver, whereby said membrane switch can transmit said signals without requiring physical connections between said transmitter and said receiver.

6. The membrane switch of claim 5 including said energy harvesting unit being a solar collector.

7. The membrane switch of claim 6 including said transmitter being integrated into said static layer.

8. The membrane switch of claim 1 including said membrane switch receiver being structured to be integrated into an external electronic circuit board.

9. The membrane switch of claim 5 including said microprocessor being structured to store and format the output of said membrane switch receiver.

10. The membrane switch of claim 2 including said micro-switch receiver including digital logic or a microprocessor whose output is structured to be received by a mechanical/electrical interface.

11. The membrane switch of claim 10 including said digital logic or microprocessor being structured to store and format the output of the receiver to provide digital code to the external electronic circuit or system through said mechanical/electrical interface.

12. The membrane switch of claim 1 including
a pair of said electrically conductive elements on either said membrane layer or said static layer, and
a shorting member on the other said layer structured to engage said pair of electrically conductive elements when said switch is in said closed position.
